(19) United States
(12) Patent Application Publication
(10) Pub. No.: US 2005/0107467 A1
(43) Pub. Date: May 19, 2005

(54) Methods for producing and using a Cu(I)-based wood preservative

(76) Inventor: H. Wayne Richardson, Sumter, SC (US)

Correspondence Address: MORGAN LEWIS & BOCKIUS LLP, 1111 PENNSYLVANIA AVENUE NW, WASHINGTON, DC, 20004, US

(21) Appl. No.: 10/965,716

(22) Filed: Oct. 18, 2004

Related U.S. Application Data
(60) Provisional application No. 60/511,648, filed on Oct. 17, 2003.

(51) Int. Cl. A01N 55/02

(52) U.S. Cl. 514/499

(57) ABSTRACT

Soluble copper(I)-amine complexes, particularly copper(I)-ammonia complexes and copper(I)-monoethanmolamine complexes, are useful injectable wood preservatives. Wood treated with the copper(I)-amine complexes contains less amines, and is less corrosive to metals, than woods treated with the prior art copper(II)-amine complexes. A method of preparing an aqueous wood preservative that includes soluble copper(I) complexes comprises reacting a solution comprising a copper(II)-amine complex with metallic copper to form a copper(I)-amine complex. One aspect of the invention comprises injecting a solution comprising a copper(I)-amine complex into wood and allowing the copper(I)-amine complex to precipitate within the wood.

### FIELD OF THE INVENTION

The present invention relates to wood preservatives, particularly wood preservatives comprising one or more soluble copper-amine compounds. More particularly, the present invention relates to methods of manufacturing wood preservatives containing copper(I)-amine complexes, more particularly copper(I)-alkanolamine complexes.

### BACKGROUND OF THE INVENTION

The primary preserved wood product has historically been southern pine lumber treated with chromated copper arsenate (CCA). Most of this treated lumber was used for decks, fencing and landscape timbers. There has recently been raised concerns about the safety and health effects of CCA as a wood preservative, primarily relating to the arsenic content but also to the chromium content. In 2003/2004, due in part to regulatory guidelines and to concerns about safety, there has been a substantial cessation of use of CCA-treated products.

A new generation of copper-containing wood preservatives uses one or more forms of soluble copper(II). Known preservatives include copper alkanolamine complexes, copper polyaspartic acid complex, alkaline copper quaternary, ammoniacal copper quaternary, ammoniacal copper zinc, copper azole, copper boron azole, copper bis(dimethyldithiocarbamate), ammoniacal copper citrate, copper citrate, and the copper alkanolamine carbonate complexes, particularly copper monoethanolamine carbonate. Of the many compositions listed above, substantially all contain soluble copper as either a copper alkanolamine complex or a copper ammonium complex. In practice the principal criteria for commercial acceptance, assuming treatment efficacy, is cost. The only commercially accepted treatments employ a copper alkanolamine complex or a copper ammonium complex.

There are, however, several problems with these new copper-containing preservatives. These preservatives commonly contain a second biocide that is efficacious against copper tolerant organisms, and other particularly troublesome species, e.g., particularly sapstain molds. The second biocide is often composed of an azole, a triazole, a quaternary amine, or a nitroso-amine.

These new copper(II) complex-containing wood preservatives are not without problems, however. For instance, these preservatives are water soluble and thus sufficiently mobile so as to be spontaneously leached from the wooden substrate at much faster rates than CCA. This leaching from the substrate compromises the long term efficacy of the formulation, and may eventually increase further increase the cost as manufacturers increase the amount of product in the wood, i.e., the copper loading, usually expressed in pounds of copper per cubic foot. The AWPA Retention Standards for CBA-A are from 0.20 to 0.61 pounds per cubic foot, for example.

These preservatives are also more expensive than the CCA formulations on a pound-for-pound basis. A large part of the cost is the solvent, e.g., the alkanolamine and the ammonia. It takes between three and four molecules of the alkanolamine or ammonia to complex and solvate one cupric ion. Ammonia is typically less expensive than an alkanolamine, and it is commonly used in many primarily western states. Monoethanolamine is preferred in the eastern US, most likely because it does not have the odor and irritating fumes that can be given off from ammonia-based treatments.

The commercial soluble copper containing wood preservatives often result in increased metal corrosion, for example of nails within the wood. Preserved wood products are often used in load-bearing out-door structures such as decks. Traditional fastening material, including aluminum and standard galvanized fittings, are not suitable for use with wood treated with these new preservatives. Many regions are now specifying that hardware, e.g., fittings, nails, screws, and fasteners, be either galvanized with 1.85 ounces zinc per square foot (a G-185 coating) or require Type 304 stainless steel. Generally, the presence of any salt will induce corrosion. We believe that the amines present in the treatments used in soluble copper treatments—alkanolamines, ammonia, and the like—contribute to corrosion to metals. We also believe that another problem with the amines present in the treatments used in soluble copper treatments is they are, or they eventually turn into, biodegradable nitrogen-containing material that can encourage certain biological attacks, particularly mildew. Wood is naturally resistant to mildews in part because there is very little fixed nitrogen in wood. The commonly used soluble copper compounds provide nitrogen-containing nutrients (amines) which are believed to act as food-stuff and causes an increase in the presence of sapstain molds, therefore requiring additional biocides effective on sapstain molds to be added to protect the external appearance of the wood.

Finally, the compositions are also necessarily manufactured and distributed as fairly dilute solutions—e.g., aqueous copper(I)-alkanolamine complexes contain at most between about 12% and about 13% by weight copper. Since the preservative solution is manufactured in central locations but applied to the wood in many decentralized areas, the freight cost required to ship the material to the treating operations is a substantial part of the end-use cost of these preservatives. Consequently, the cost of preserved wood product exceeds the cost of the CCA-based wood products it was designed to replace.

A need therefore exists to develop a new copper-containing wood preservative and method of manufacturing the same to overcome the aforementioned limitations.

### SUMMARY OF THE INVENTION

The present invention provides a method of preparing a new generation wood preservative that employs the use of complexed copper(I) ions. While compositions such as cuprous ammoniacal salts are known and are used in the petrochemical industry, for example cuprous ammoniacal acetate is used butadiene from byproducts of ethylene manufacture, such compositions have not been used in wood preservation. The copper metal can be provided in pre-packaged mixtures or compositions, optionally but preferably containing additional ingredients useful in preparing and stabilizing a composition comprising copper(I) amine complexes. Compositions of this invention decrease costs associated with soluble copper preservatives because less amine is needed to solubilize and transport copper(I) amine complexes, compared to copper(II) complexes. Additionally, the fixated product of the copper(I) amine product is believed to favor formation of more Cu₂O, an active product that leaches from the wood at a slower rate than does the fixation products of copper(II) amine compositions. The copper(I) amine complexes will also reduce corrosion. First, we believe that the presence of the amines (or oxidated products thereof such as aminoacetic acid) promote corrosion, and the copper(I) complexed material of this invention comprises less amines per molecule of copper than does the prior art copper(I) amine compositions. Further, the copper(I) ion is a weaker oxidizer than the copper(I) ion and therefore does not promote the oxidation of iron, for example, to the extent the copper(I) ion promotes corrosion.

A most preferred embodiment of the invention is a wood preservative composition comprising a copper(I)-alkanolamine complex. The preferred alkanolamines are monoethanolamine, diethanolamine, and isopropanolamine. The most preferred alkanolamine is monoethanolamine. The preferred copper(I)-alkanolamine complex is copper(I)-monoethanolamine complex, alternately written as “Cu(I)-(MEA)₂⁺”, which is advantageously stabilized with an anion, for example a: carbonate ion; acetate; formate; citrate; chloride; bromide; fluoride; iodide; sulfate; borate; phosphate; sulfide; azide; chromite; cyanide; ferricyanide, or any combinations thereof. Carbonate ions (including bicarbonate ions) are one preferred component because they can be inexpensively made, by for example contacting an alkaline composition with carbon dioxide. Ascorbate ions are another preferred anion, due to its anti-oxidant activity, but it is generally impractical to use due to expense and to difficulties in manufacturing the precursor copper(II) complex composition. Borates are preferred due to the biocidal activity of borates. Likewise, fluorides are also preferred. In more preferred embodiments, the wood preservative composition concentrates that are admixed with water to form injectable wood preservative compositions of this invention comprise at least 0.1%, preferably at least 0.5%, more preferably at least 1%, for example at least 2% by weight of copper(I)-monoethanolamine-anion complex, for example [Cu(I)-(MEA)₂]₂—CO₃ (where monoethanolamine is represented by “MEA”). The amount of copper(I) in the injectable wood preservative will depend on the desired retention of copper and on the ratio of cuprous to cupric ions in the composition. A copper(II)-monoethanolamine-anion complex requires about 3.5 to 4 monoethanolamine molecules per atom of copper, eg, Cu-(, while a copper(I)-monoethanolamine-anion complex requires about 2 monoethanolamine molecules per atom of copper. In preferred embodiments of this invention, the wood preservative composition comprises both a copper(II)-monoethanolamine-anion complex and copper(I)-monoethanolamine-anion complex. The copper(I)-monoethanolamine-anion complex in an aqueous composition becomes unstable in the presence of oxidizers, e.g., air, especially when heated. The cuprous ion is oxidized to the cupric ion. Unless there is sufficient additional alkanolamine present to complex the amount of cuprous ions that are oxidized to cupric ions, e.g., about an additional 3 alkanolamine molecules per two cuprous ions oxidized, copper salts will precipitate. In another preferred embodiment the wood preservative composition comprises a small excess of alkanolamine, providing for example between 2.1 to 3.4, to example from 2.2 to 3, molecules of the alkanolamine per atom of copper. Additionally, a small excess of the anion is beneficially present, for example as part of a buffer to control pH. In another preferred embodiment the wood preservative composition comprises an effective amount, e.g., between 0.3 ppm to 500 ppm, for example from 3 ppm to 30 ppm, of one or more antioxidants.

A preferred embodiment of the invention is a wood preservative composition comprising a copper(I)-ammonia complex. The preferred copper(I)— ammonia complex is also advantageously stabilized with an anion. In more preferred embodiments, the wood preservative composition concentrates that are admixed with water to form injectable wood preservative compositions of this invention comprise at least 0.1%, preferably at least 0.5%, more preferably at least 1%, for example at least 2% by weight of copper(I)-ammonia-anion complex, for example [Cu(I)—(NH₃)₂]₂—CO₃. A copper(II)-ammonia-anion complex requires about 3.5 to 4 ammonia molecules per atom of copper, while a copper(I)— ammonia-anion complex requires about 2 ammonia molecules per atom of copper. In preferred embodiments of this invention, the wood preservative composition comprises both a copper(II)-ammonia-anion complex and copper(I)-ammonia-anion complex in an aqueous composition. The copper(I)-ammonia-anion complex becomes unstable in the presence of oxidizers, e.g., air, especially when heated. The cuprous ion is oxidized to the cupric ion. Unless there is sufficient additional ammonia present to complex the amount of cuprous ions that are oxidized to cupric ions, e.g., about an additional 3 ammonia molecules per two cuprous ions oxidized, copper salts will precipitate. In another preferred embodiment the wood preservative composition comprises a small excess of ammonia, providing for example between 2.1 to 3.5, to example from 2.2 to 3, molecules of the ammonia per atom of copper. Additionally, a small excess of the anion is beneficially present, for example as part of a buffer to control pH. In another preferred embodiment the wood preservative composition comprises an effective amount, e.g., between 0.3 ppm to 500 ppm, for example from 3 ppm to 30 ppm, of one or more antioxidants.

Another wood preservative composition of this invention comprises copper(I)-alkanolamine-ammonia complex, e.g., a copper(I)-alkanolamine-ammonia-anion complex. The ammonia is substantially interchangable with monoethanolamine. By a copper(I)-alkanolamine-ammonia-anion complex we mean to include both individual complexes containing both ammonia and an alkanolamine, e.g., Cu(I)-(MEA)₂—CO₃. and also compositions containing both a copper(I)-alkanolamine-anion complex and a copper(I)-ammonia-anion complex. In preferred embodiments of this invention, the wood preservative composition comprises both a copper(I)-alkanolamine-ammonia-anion complex and a copper(II)-alkanolamine-ammonia-anion complex in an aqueous composition. Unless there is sufficient additional ammonia and/or alkanolamine present to complex the amount of cuprous ions that are oxidized to cupric ions, e.g., about an additional 3 molecules total of ammonia and alkanolamine per two cuprous ions oxidized, copper salts will precipitate. In another preferred embodiment the wood preservative composition comprises a small excess of ammonia, providing for example between 2.1 to 3.5, to example from 2.2 to 3, molecules total of ammonia and alkanolamine per atom of copper. Additionally, a small excess of the anion is beneficially present, for example as part of a buffer to control pH. In another preferred embodiment the wood preservative composition comprises an effective amount, e.g., between 0.3 ppm to 500 ppm, for example from 3 ppm to 30 ppm, of one or more antioxidants.

As stated above, aqueous compositions of copper(I)-alkanolamine-anion complexes, copper(I)-ammonia-anion complexes, and copper(I)-alkanolamine-ammonia-anion complexes are generally thermodynamically unstable in water containing oxidants, e.g., dissolved air. This creates obvious shipping and storage problems. For this reason, the invention also includes a point of use method of manufacturing a wood preservative composition comprising copper(I)-alkanolamine-anion complex and/or a copper(I)-ammonia-anion complex.

According to one aspect of the present invention, a solution comprising a copper(I)-monoethanolamine-anion complex can be produced by contacting a solution comprising copper(II)-monoethanolamine-anion complex with copper metal. In this method, air is advantageously excluded, both mechanically for example with a closed tank and a carbon dioxide head over the fluid and/or chemically, for example by using one or more antioxidants. The anion in the complex can comprise ascorbate, as this compound is an anti-oxidant. Generally, however, any effective amount, for example from 10 ppm to 1000 ppm, of one or more common inexpensive antioxidants such as sodium sulfite and sodium hydrogen-sulfite are preferred. The reaction to convert a cupric ion and a metallic copper ion into two cuprous ions does not need any external driving force. In a simple embodiment, an operator may wish to prepare an injectable wood preservative composition in a closed tank by admixing an aqueous concentrate comprising copper(II)-monoethanolamine-anion complex and optionally other adjuvants such as antioxidants, surfactants, and the like with water, and then adding to the tank copper metal, where the copper metal is beneficially in a form providing high surface area. However, the reaction kinetics are typically limited by the effective contact area of the copper metal to the fluid and also by the concentration of available cupric ions in solution.

A preferred method of manufacture is by vigorously contacting an aqueous concentrate comprising copper(II)-monoethanolamine-anion complex and optionally other adjuvants such as antioxidants, surfactants, and the like with the copper metal in a form providing high surface area for a time sufficient to dissolve some metallic copper, forming at least 0.1% by weight of a copper(I)-monoethanolamine-anion complex, and then admixing this formulation with water, advantageously pretreating the water with antioxidants if the water is aerated surface water. The aqueous concentrate comprising copper(II)-monoethanolamine-anion complex beneficially comprises between 8 and 14% by weight copper (typically entirely in the form of cupric ions), for example between 10 and 12% by weight of copper. Contacting can be achieved by adding granular copper, copper shavings, bent or saddle-shaped copper plates, copper tubes, copper wire, copper cable, blister shot, or such to the tank with stirring, or by pumping (and beneficially recirculating) the concentrate through a basket comprising granular copper, copper shavings, bent or saddle-shaped copper plates, copper tubes, copper wire, copper cable, blister shot, or such, and having screens therein to prevent migration of pieces of the metallic copper. The copper is beneficially finely divided to give a high surface area, or forms an open network that is permeable to fluid, or both.

According to another aspect of the present invention, a solution comprising a copper(I)-ammonia-anion complex can be produced by contacting a solution comprising copper(II)-ammonia-anion complex with copper metal. In this method, air is advantageously excluded, both mechanically for example with a closed tank and a carbon dioxide head over the fluid and/or chemically, for example by using one or more antioxidants. Again, any effective amount, for example from 10 ppm to 1000 ppm, of one or more common inexpensive antioxidants such as sodium sulfite and sodium hydrogen-sulfite are preferred. In a simple embodiment, an operator may wish to prepare an injectable wood preservative composition in a closed tank by admixing an aqueous concentrate comprising copper(II)-ammonia-anion complex and optionally other adjuvants such as antioxidants, surfactants, and the like with water, and then adding to the tank copper metal, where the copper metal is beneficially in a form providing high surface area. However, the reaction kinetics are typically limited by the effective contact area of the copper metal to the fluid and also by the concentration of available cupric ions in solution.

A preferred method of manufacture is by vigorously contacting an aqueous concentrate comprising copper(II)-ammonia-anion complex and optionally other adjuvants such as antioxidants, surfactants, and the like with the copper metal in a form providing high surface area for a time sufficient to dissolve some metallic copper, forming at least 0.1% by weight of a copper(I)-ammonia-anion complex, and then admixing this formulation with water, advantageously pretreating the water with antioxidants if the water is aerated surface water. Contacting can be achieved by adding grandular copper, copper shavings, or such to the tank with stirring, or by pumping (and beneficially recirculating) the concentrate through a basket comprising grandular copper, copper shavings, or such, and having screens therein to prevent migration of pieces of the metallic copper.

In one embodiment of the invention, the wood preservative composition comprises soluble copper(I) complexes and soluble copper(II) complexes in a ratio greater than 0.005:1, for example between about 0.01:1 to about 100:1, alternatively between about 0.05:1 to about 3:1, or between about 0.1:1 to about 1:1, where the weight is the weight of the copper ions only. In another embodiment, the wood comprises copper(I) complexes and substantially no copper(II) complexes. The wood preservative compositions of all embodiments of this invention can, and preferably does, further comprise one or more of the organic and/or inorganic co-biocides as is known in the art, e.g., azoles, triazoles, quaternary amines, metallic borates, etc.

Another aspect of the present invention comprises injecting a wood preservative composition comprising a copper(I)-alkanolamine-anion complex, a copper(I)-ammonia-anion complex, or a copper(I)-(alkanolamine-ammonia)-anion complex into wood and allowing the complex to precipitate or set-up within the wood. In one embodiment, the wood preservative composition comprises soluble copper(I) complexes and soluble copper(II) complexes in a ratio greater than 0.005:1, for example between about 0.01:1 to about 100:1, alternatively between about 0.05:1 to about 3:1, or between about 0.1:1 to about 1:1, where the weight is the weight of the copper ions only. In one embodiment a vacuum is pulled on the wood prior to injecting the wood preservative composition of this invention, to minimize exposure to air during drying. Alternately or additionally, the wood can be pre-impregnated with carbon dioxide, nitrogen, or other inert gas to minimize air within the wood.

One important advantage to this system is that no externally applied current is needed to oxidize copper metal to copper(I) ions. Of course, in alternate embodiments, an operator can impose a small voltage, for example between about 0.1 V and 12 V, to facilitate oxidation of copper metal. Such current would be electrically connected to the copper metal. Generally, a larger current may be inclined to produce additional copper(II) ions, which is useful to utilize any excess alkanolamine and/or ammonium in the starting fluid. Generally, fluids are shipped with a small excess of alkanolamine and/or ammonium, and the fluid therefore can complex a small amount of additional copper(II) ions in an alkanolamine/ammonium complex. The presence of the small excess of copper (II) ions, compared to the complexing (solvating) capacity of the fluid, may facilitate the formation of copper (I) ions from copper metal and copper(II) ions. However, it is important that the voltage eventually be reduced below that needed to oxidize copper, because unless copper(II) ions are reduced to copper(I) ions as copper metal is oxidized to copper(I) ions, the solution will become supersaturated with copper ions and precipitation and other problems will occur.

Another aspect of the present invention comprises treated wood having a copper(I)-alkanolamine-anion complex, e.g., a copper(I)-monoethananolamine-carbonate complex, a copper(I)-ammonia-anion complex, or a copper(I)-(alkanolamine-ammonia)-anion complex in an amount between 0.01 and 1 pound of copper per cubic foot of wood, typically between 0.05 and 0.6 pounds of copper per cubic foot of wood. In one embodiment, the wood comprises copper(I) complexes and copper(II) complexes in a ratio greater than 0.005:1, for example between about 0.01:1 to about 100:1, alternatively between about 0.05:1 to about 3:1, or between about 0.1:1 to about 1:1, where the weight is the weight of the copper ions only. In another embodiment, the wood comprises copper(I) complexes and substantially no copper(II) complexes.

Another aspect of the present invention comprises treated wood having the reaction product of wood and a wood preservative comprising a copper(I)-alkanolamine-anion complex, e.g., a copper(I)-monoethananolamine-carbonate complex, a copper(I)-ammonia-anion complex, or a copper(I)-(alkanolamine-ammonia)-anion complex in an amount between 0.01 and 1 pound of copper per cubic foot of wood, typically between 0.05 and 0.6 pounds of copper per cubic foot of wood, wherein the wood has been dried. In one embodiment, the wood preservative composition comprises soluble copper(I) complexes and soluble copper(II) complexes in a ratio greater than 0.005:1, for example between about 0.01:1 to about 100:1, alternatively between about 0.05:1 to about 5:1, or between about 0.1:1 to about 2:1. Compositions having such ratios of complexed copper(I) to complexed copper(II) can be readily formed from precursor compositions having exclusively complexed copper(II), where the soluble copper(II) complexes happen to be the compounds used in current soluble copper wood preservatives. In another embodiment, the wood preservative composition comprises soluble copper(I) complexes and substantially no soluble copper(II) complexes.

The copper monoethanolamine carbonate composition can be produced as disclosed in the U.S. patent application publication No. 20030162986, published Aug. 28, 2003 by Richardson and Zhao (2003) or by the dissolution of copper carbonate in monoethanolamine solutions. This solution is then contacted with copper metal with agitation, for example by stirring or by recycling solution past the metal by pumping the solution e.g., from the bottom of the tank and returned to the top of the tank until the copper concentration has increased by at least about 5%, for example at least about 10%, preferably at least about 25 percent and up to about 100%. This solution can then be diluted with water to a nominal use copper concentration of 0.5 or 1.0 percent, and the pH is adjusted to around 8.0 by carbonating, if necessary, or adding additional MEA.

Another aspect of the present invention comprises treated wood having the reaction product of a wood preservative comprising an aqueous copper(I)-alkanolamine-anion complex, e.g., a copper(I)-monoethananolamine-carbonate complex, an aqueous copper(I)-ammonia-anion complex, or an aqueous copper(I)-(alkanolamine-ammonia)-anion complex, wherein the wood after having been injected and allowed to age as is known in the art has been kiln dried at temperatures known in the art. Another aspect of the present invention comprises treated wood having the reaction product of a wood preservative comprising a aqueous copper(I)-alkanolamine-anion complex, e.g., a copper(I)-monoethananolamine-carbonate complex, an aqueous copper(I)-ammonia-anion complex, or an aqueous copper(I)-(alkanolamine-ammonia)-anion complex, wherein the wood after having been injected and allowed to age as is known in the art has been exposed to microwaves as is known in the art.

### DETAILED DESCRIPTION OF EMBODIMENTS

One aspect of the present invention relates to a method that minimizes the costs associated with the manufacture and shipment of the soluble copper solutions, which are used in many industries but are most commonly used as a component of wood preservative treatments. It is believed that wood treated with the wood preservative compositions of this invention, e.g., comprising an aqueous copper(I)-alkanolamine-anion complex, e.g., a copper(I)-monoethananolamine-carbonate complex, an aqueous copper(I)-ammonia-anion complex, or an aqueous copper(I)-(alkanolamine-ammonia)-anion complex, have a reduced rate of leaching from the wood substrate, and also a reduced degree of severity of corrosion of metal fittings contacting the wood, and also a reduced tendency to support molds, as compared to a comparable wood preservative made from compositions consisting essentially of an aqueous copper(II)-alkanolamine-anion complex, e.g., a copper(II)-monoethananolamine-carbonate complex, an aqueous copper(II)-ammonia-anion complex, or an aqueous copper(II)-(alkanolamine-ammonia)-anion complex.

When manufacturers are making the copper(II)-alkanolamine complex or the copper(II)-ammonia complex they generally add air as the oxidant to convert metallic copper to the cupric ion. Copper(I) is thermodynamically unstable in this environment—it will be oxidized to copper(II). Therefore, cuprous ions are not present in these compositions. If, however, the oxidants are removed after the desired cupric ion loading is achieved, typically at about 10% to 12.5% copper by weight, and then the composition is further allowed to react with copper metal, then the composition will for soluble cuprous complexes and the copper loading of the composition will increase. The method comprises reacting a solution comprising a copper(II)-alkanolamine complex with copper metal to form a copper(I)-alkanolamine complex. Alternatively, the reaction comprises reacting a solution comprising a copper(II)-ammonia complex with copper metal to form a copper(I)-ammonia complex.

Because aqueous compositions comprising an aqueous copper(I)-alkanolamine-anion complex, e.g., a copper(I)-monoethananolamine-carbonate complex, an aqueous copper(I)-ammonia-anion complex, or an aqueous copper(I)-(alkanolamine-ammonia)-anion complex, are unstable in the presence of air, these compositions have not been used for in wood preservatives. These soluble copper(I) complexes have several advantages over the prior art aqueous copper(II)-alkanolamine-anion complex, e.g., a copper(II)-monoethananolamine-carbonate complex, an aqueous copper(II)-ammonia-anion complex, or an aqueous copper(II)-(alkanolamine-ammonia)-anion complex. First, the mole ratio of nitrogen-containing compounds to copper is lower in the composition of the present invention. The mole ratio of Cu to alkanolamine/ammonia is advantageously between 1:2 and 1:3.5, for example between 1:2.2 and 1:3. Therefore, cost of the non-biocidal solvent component is reduced compared to the prior art copper(II) formulations. As the amount of copper in a concentrated copper(I)-complex composition can exceed the saturation level of a concentrated copper(II)-complex composition, the shipping costs per pound of copper of the concentrated solutions of soluble copper complexes can be reduced. Further, the shipping cost to treat a given quantity of wood can be lowered further if the reaction with copper metal is rendered at the site where the wood is treated. Further, the amount of biodegradable nitrogen-containing compounds in the wood is reduced. Additionally, the copper(I) species is less mobile, and therefore will leach at a slower rate, than most copper(II) species. The copper(I)-based complexes are relatively more easily hydrolyzed to copper(I) oxide, Cu₂O, and in the process be made less mobile the corresponding copper(II) species yet still be an effective biocide. Finally, the copper(I) species is less corrosive to aluminum and iron than is the copper(II) species, so corrosion of fillings and joiners is reduced relative to that occurring in wood with the same wood preservative loading and adjuvants, but using the copper(II) complex. In some environments, such as drying in an inert atmosphere and beneficially under a partial vacuum, a quantity of the copper(I) will partially react to form copper(II) species and metallic copper. Metallic copper is also believed to actively reduce corrosion.

The preferred wood preservative composition comprises both soluble copper(I) complexes and soluble copper(II) complexes. This composition is preferred because it is typically much less expensive to manufacture than is a composition comprising only soluble copper(I) complexes. As previously stated, the preferred method of obtaining the solution comprising the desired complexed copper(I) compounds is to start with a solution of complexed copper(II) compounds, and contact this composition in an oxidant-free environment with copper metal.

The term “copper” as used herein means copper metal, including scrap copper, such as, for example, copper wire, copper clippings, copper tubing, copper cabling and/or copper plate, compounds of copper, such as copper oxide, and/or mixtures of copper metal and copper compounds. The copper metal used in the practice of this invention may be in any convenient form which provides a sufficient surface area for reaction. The copper may be in powdered form, although larger particles, for example, turnings or scrap copper, may alternatively be used. Scrap copper wire is particularly useful, for example. The key is to have an adequate surface area of copper. A variety of configurations can be used to provide adequate surface area of copper if the reaction takes place in a centralized plant, e.g., long packed towers and such. The surface area of the copper metal can range from about 1×10⁻⁶ m²/g to about 500 m²/g. If the reaction of a copper(II) composition is to take place at point of use, the reactants are beneficially compact. The surface area of the copper metal should then typically range from about 1×10⁻⁵ m²/g to about 500 m²/g, for example from about 1×10⁻⁴ m²/g to about 70 m²/g, or for example from 10 m²/g to about 60 m²/g.

Very thin coatings of oils and/or inerts such as copper oxides can block the reaction. The copper metal is advantageously free of grease. Preferably the copper is in reactive form and it may, advantageously, be mildly etched, for example with a dilute mineral acid/hydrogen peroxide mixture to ensure this. It is within the skill of one of ordinary skill in the art, having the benefit of this disclosure, to select the appropriate acid composition and strength needed to remove surface impurities and expose active copper metal within the temperature and time constraints they may be under. Contacting copper with a 0.5 N aqueous hydrochloric acid or aqueous 10% acetic acid at ambient temperature for between 20 and 120 seconds will generally suffice, for example. Only small quantities of acid are needed relative to the amount of wood preservative typically manufactured, and generally the acid can simply be added to the wood preservative composition, where it will lower the pH of the wood preservative composition by at most a few tenths of one pH unit.

Advantageously, the starting composition comprising the copper(I) complexes does not contain film-forming type corrosion inhibitors. Many commonly used co-biocides in wood preservatives, including those co-biocides having limited solubility and also co-biocides added to wood preservatives as emulsions, will plate onto and form films onto the copper. For example, e.g., benzotriazole is somewhat soluble in aqueous formulations but is a very good film forming agent for copper metal. Advantageously, the co-biocides are therefore admixed with the solubilized copper-containing composition only after the reaction of the composition with metallic copper is complete.

There is considerable cost pressure on soluble copper wood preservatives, and only those treatments with the lowest cost can be economically useful. The above-listed complexing agents in the preferred embodiments of the invention are ammonia and and alkanolamine selected from monoethanolamine, isopropanolamine and diethanolamine. The most preferred complexing agents are ammonia and monoethanolamine. They are less expensive than the other alkanolamines, and they are both very efficient complexing agents for both copper(II) and for copper(I) in aqueous compositions. Ammonia is the least expensive complexing agent, but the cost differential is off-set because monoethanolamine does not have the irritating and occasionally harmful fumes that ammonia compositions can release. Although less preferred than either ammonia or monoethanolamine, other compounds can be used to generate and/or stabilize soluble copper(I) complexes to the extent necessary for utilization in soluble copper wood preservative compositions. One class of useful complexing compounds is other alkanolamines and alkanolamine derivatives. Exemplary compounds include for example diglycolamine, 2-(N-methylamino) ethanol (“monomethyl ethanolamine”), 2-[(2-aminoethyl)-(2-hydroxyethyl)-amino]-ethanol (“N,N-bis-hydroxyethyl-ethylenediamine”), N,N,N-tris-(2-hydroxyethyl)-ammonia (“triethanolamine”), N-aminoethyl-N′-hydroxyethyl-ethylenediamine, N,N′-dihydroxyethyl-ethylenediamine, 2-[2-(2-aminoethoxy)-ethylamino]-ethanol, 2-[2-(2-aminoethylamino)-ethoxy]-ethanol, 2-[2-(2-aminoethoxy)-ethoxy]-ethanol, tertiarybutyldiethanolamine, diisopropanolamine, 3-amino-1-propanol (“n-propanolamine”), isobutanolamine, 2-(2-aminoethoxy)-propanol; 1-hydroxy-2-aminobenzene; or the like, or any combination thereof, or any combination thereof and including ammonia and/or any of the preferred alkanolamines. Generally, the cost of these components are prohibitive compared to monoethanolamine, and these other compounds add substantial quantities if additional bio-available carbon and/or nitrogen to the wood with very little if any added benefit because of slightly reduced leach rates for some of the embodiments. Another class of useful complexing compounds is ethylenediamine and ethylenediamine derivatives. Exemplary compounds include for example ethylenediamine, ethylenediamine diformic acid, and the like. Ethylamine is too strong an irritant and fire hazard to be widely used. EDTA is generally too expensive to use, and is also too strong a chelator, and will generally prevent copper(II) complexes from reacting with copper metal at a useful rate. Ethylene diamine typically costs more than monoethanolamine, adds twice the amount of bio-available nitrogen to the wood as does monoethanolamine. Also, the flash point of ethylenediamine is only 34 C, just above ambient temperature, compared to the 93 C flashpoint of ethanolamine. Therefore, there are operational safety hazards with ethylene diamine which are not presented by ethanolamine. Another class of compounds that can complex with and stabilize copper(I) in an aqueous composition are soluble nitrites, for example acetonitrile, propionitrile, and butyronitrile. These compounds have very low flash points and are therefore high fire risks, and these products exhibit some toxicity even via contacting skin. For the various reasons stated above, these various complexing agent are not preferred. However, if they can be obtained inexpensively, for example as contaminants in compositions comprising one or more preferred complexing agents, they can be useful. It is preferred that these components be present, if at all in minor (1% to 20%) or trace (<1%) quantities, based on the weight of the total complexing agents.

The copper(II)-MEA complex above can be manufactured in a stable and soluble condition in concentrations up to about 12 percent copper(II). It is usually, however, formulated and shipped at a copper concentrations of less than 10%, for example copper concentrations of about 8 or 9%. The manufacture of the monoethanolamine precursor copper(II) complexes in an alkaline media can be achieved under for example the following schemes: CuCO₃+(3.5 to 4.0)MEA→Cu(MEA)_{(3.5-4.0)}]CO₃; Cu(OH)₂+(3.5 to 4.0)MEA→[Cu(MEA)_{(3.5-4.0)}](OH)₂; Cu+1/2O₂+CO₂+aqueous (3.5-4.0)MEA→Cu(MEA)_{(3.5-4.0)}]CO₃, and so forth. The precursor complex is typically expressed as having 4 complexing molecules per molecule of cupric ion. Monoethanolamine solutions, however, have a slight added stability so that the empirical observation shows that as little as 3.5 complexing molecules can solubilize a cupric ion. The typical precursor monoethanolamine composition therefore comprises between 3.5 and 4 complexing molecule per molecule of copper(II). A copper(II) ion can react quantitatively with copper metal to give two cuprous ions, and the desired complex requires two complexing molecules per atom of copper. Therefore, some starting compositions may have insufficient numbers of complexing molecules. For example, a composition having 3.6 molecules of complexing agent per molecule of cupric ion can react with copper to form a composition of about 3.5 molecules of complexing agent per molecule of cupric ion, along with a small amount of the desired copper(I) complex having two complexing molecules thereon. However, the amount of copper(I) formed will be small and the kinetics slow. A preferred starting composition comprises an aqueous solution of copper(II) monoethanolamine complexes where the quantity of complexing monoethanolamine molecules is between 3.7 and 4.3 molecules per cupric ion, more preferably between 3.9 and 4.1 molecules monoethanolamine per cupric ion, more preferably about 4 molecules monoethanolamine per cupric ion.

The same pathways can be used with ammonia and copper, though typically the number of complexing ammonia molecules is closer to 4 or above 4, e.g., a preferred precursor compositon preferably has between 3.9 and 4.2 molecules ammonia per cupric ion, more preferably about 4 molecules ammonia per cupric ion.

In another embodiment of the invention, cupric salts can be used in the reaction with an alkanolamine. The stabilizing anions in the reaction oxidizing metallic copper are generally the same anions used in the copper salts. The following anionic groups are useful: phosphate, chloride, bromide, borate, sulfate, sulfite, sulfide, azide, bromide, chromite, cyanide, ferricyanide, fluoride, and iodide. Other useful anionic groups include: carbonate ion; acetate; formate; citrate; borate; chromite; and ferricyanide. The salts can be any combination of the above. Carbonate ions (including bicarbonate ions) are one preferred component because they can be inexpensively made, by for example contacting an alkaline composition with carbon dioxide. Borates are preferred due to the biocidal activity of borates. Likewise, fluorides are also preferred due to biocidal activity.

In another embodiment, a composition comprising copper(I) complexes can be formed by mixing copper(I) salts with the complexing agent, but this method can generally not compete economically with the preferred method of manufacture described here. If a composition comprises for example un-complexed ammonia or monoethanolamine, simply adding the cuprous salts to the liquid composition will give the desired copper(I) complexes. Generally, however, most copper(I) salts degrade on exposure to air and/or light, and are insoluble and thermodynamically unstable in water. Therefore, the kinetics of forming the cuprous ammonium complex, cuprous alkanolamine complex, and the like can be slow. The most useful cuprous salts useful to form an aqueous composition comprising copper(I) complexes are cuprous chloride, cuprous iodide (often used in cloud-seeding), and/or cuprous sulfite (which can stabilize the composition by removing dissolved oxygen). To make a composition comprising copper(I) complexes and copper(II) complexes, one or more of these salts can be dissolved in the aqueous prior art compositions of ammoniacal copper(II) complexes and in aqueous solutions of copper(II)-alkanolamine, provided there is excess ammonia or alkanolamine, respectively.

A precursor solution comprising copper(II), such as one prepared in accordance with one or both of the above mentioned reaction schemes, may be reacted with copper metal to prepare a solution comprising copper(I). This reaction is illustrated with the equation below:
[Cu(MEA)_{(3.5-40.0)}]CO₃+[Cu(MEA)_{(3.5-4.0)}](OH)₂+2Cu⁰→
[Cu(MEA)_{(1.75-20.0)}]₂CO₃+2[Cu(MEA)_{(1.75-2.0)}](OH)

In one embodiment, the above-described reactions can occur at temperatures ranging from about 10° C. to about 60° C., and preferably from about 18° C. to about 40° C. In another embodiment, the pH of the above-described reactions ranges from about 8 to about 12.5, and preferably from about 8.5 to about 11.

The compositions and methods of the present invention provide the additional benefit that they are less corrosive than are the traditional copper(II) amine formulations. The copper(II) amine formulations of the prior art have a tendency to substantially increase corrosion rates of metal that contacts the wood. Preserved wood products are often used in load-bearing outdoor structures such as decks. Traditional fastening material, including aluminum and standard galvanized fittings, are not suitable for use with wood treated with these cupric amine based preservatives. Many regions are now specifying that hardware, e.g., fittings, nails, screws, and fasteners, be either galvanized with 1.85 ounces zinc per square foot (a G-185 coating) or require Type 304 stainless steel. We believe that the amines present in soluble copper treatment methods—alkanolamines and ammonia, for example—contribute to the corrosion of metals. We also believe that another problem with the amines is they are, or they eventually turn into, biodegradable material that can encourage certain biological attacks, particularly mildew. The commonly used soluble copper compounds provide nitrogen-containing nutrients (amines) which are believed to act as food-stuff, causing an increase in the presence of sapstain molds, and therefore requiring additional biocides effective on sapstain molds to be added to protect the external appearance of the wood. The problem is exacerbated when bio-available carbon sources are present in addition to bio-available nitrogen.

In most of the soluble cupric amine compositions, there are between 3.5 and 4 atoms of organic nitrogen that act as a complexer or carrier for one atom of copper. Advantageously, the wood preservative used in the methods of the present invention comprises between 1.75 and 3.5 moles, preferably 2 to 3 moles, for example 2.2 to 2.7 moles of alkanolamine, ammonia, or mixture thereof per mole of soluble copper. Note this ratio does not include amines used as a supplemental biocide.

Another embodiment of the invention involves a method for preserving wood, comprising injecting a solution comprising a copper(I)-alkanolamine complex into the wood and allowing the copper(I)-alkanolamine complex to precipitate within the wood. In another embodiment, the above-described method for preserving wood is carried out a temperature of from about 12° C. to about 55° C. In another embodiment, the pH of the solution comprising copper(I)-alkanolamine injected into the wood is from about 7.5 to about 12, preferably from about 8 to about 11. In another embodiment, the pressure at which the copper(I)-alkanolamine complex is injected into the wood is from about 10 to about 200 psig. In one embodiment, the concentration of copper(I) ions and copper(II) ions together is from about 0.2% to about 2% by weight, and preferably from about 0.5% to about 1% by weight. In another embodiment, the concentration of copper(I) ions is from about 0.2% to about 2% by weight, and preferably from about 0.5% to about 1% by weight.

The hydrocarbon composition can include one or more hydrophobic oils, and/or may comprise an organic compound having one or more polar functional groups which increase adherence, for example: mono- and/or poly-carboxylic acids that may be at least partially neutralized with a metal such as a fatty acid or a polycarylic polymer, a surfactant and/or a disbursing agent, amphoteric agents, an organic biocide including an amine, azole, triazole, or any other organic biocides, a film-forming polymer such as a sulfonated ionomer, or mixtures thereof.

The copper is beneficially added at the place where the wood is to be treated. However, it may not be easy for an operator to keep and maintain conditions for allowing the efficient contacting of a cupric-amine complex to active copper surfaces. For this reason, prepackaged systems are useful. The pre-packaged systems provide copper in a contactable form, and may provide one or more adjuvants.

To react copper metal with an aqueous copper(II) amine complex, the surface area should be maximized. The greatest surface area can be obtained with finely divided copper particles, e.g., sub-micron particulates. Such particles, however, may not be easily handled, react with air and moisture to form some oxides on the surface, and run risk of very fast uncontrolled oxidation under some circumstances. Therefore, the copper particulates are advantageously stored in a medium which allows better handling, which protects the copper particles from dirt and oils, and which addresses the oxides issue to provide the most active composition available. Advantageously, when the powder or granules are admixed with the aqueous copper(II) amine complex, the powder or granules form a dispersed composition containing suspended very fine particulates of copper having clean active surfaces, for reaction with the copper(II) ions. In one embodiment, a pre-packaged system for admixing with an aqueous copper(I) amine complex comprises a powder or granulated material comprising very finely divided copper material, for example having an average particle size between about 0.04 microns in diameter to about 500 microns in diameter, preferably between 0.2 microns and 30 microns. The preferred mechanism for determining average particle size is the size where 50% of the weight of the copper has a calculated diameter larger than the specified diameter, where the calculated diameter is determined via Stokes law and the measured by settling velocity in isopropanol. In the granulation, auxiliary agents can be used which promote granule formation, re-wetting of the granules, and rapid decomposition and dispersion of the granules at the time the solution for use is being prepared, as well as agents which inhibit the foaming of the solution for use. The powder or granules may therefore further comprise dissolution agents, dispersion agents, suspension agents, surfactants, antifoaming agents, antioxidants, acids, or combinations thereof. Auxiliary granulation agents may be used in granules in which the active ingredient and the activator are in the same granule and/or in separate active-ingredient granules and activator granules.

Dissolution agents reactable with an aqueous basic composition may comprise small quantities of readily-dissolvable solid acids, e.g., ascorbic acid, citric acid, oxalic acid, and the like, where said material may also serve to prevent copper oxide formation (or remove traces of copper oxide on dissolution), and may also serve as a grandulating agent. Other agents promoting the decomposition of the granule, which may be polymers such as polyvinyl pyrrolidone and starch and its modified forms, or salts such as ammonium sulfate and/or ammonium sulfite, or organic water-soluble compounds such as urea, or substances capable of liberating gas, such as carbonates. Auxiliary agents should be selected, and concentrations of auxiliary agents should be limited, so that the surfaces of the copper metal are not coated or otherwise inactivated. As agents improving the suspension of the granules it is possible to use, as is commonly known, dispersants such as phenyl sulfonates, alkylnaphthalene sulfonates and polymerized naphthalene sulfonates, polyacrylic acids and their salts, polyacrylamides, polyalkoxydiamine derivatives, polyethylene oxides, polypropylene oxide, polybutylene oxide, taurine derivatives and their mixtures, and sulfonated lignin derivatives. Dispersants can be used at concentrations of about 0.1 to 50% by weight, for example from 1 to 5%, of the granular product.

A preferred granulated product comprises copper metal particulates and one or more ammonium salts such as ammonium sulfate, ammonium bisulfate, ammonium sulfite, ammonium phosphate, ammonium borate, ammonium chloride, ammonium fluoride, ammonium bromide, ammonium bicarbonate, ammonium carbonate, ammonium tartrate, ammonium bitartrate, or combinations thereof as granulating and dispersing agents, where the moles of ammonium present in the powder are between 1% and 50% of the number of moles of copper metal. Ammonium salts such as ammonium sulfate can provide the added amines which may beneficially increase the conversion of copper metal to copper(I) in the presence of copper(II) amine complexes. As little as one mole of ammonium sulfate per 4 moles of copper metal will provide sufficient amine for total conversion.

In another embodiment a slurry is provided comprising a slurry of a liquid and copper metal. The copper metal is advantageously very finely divided copper material, for example having an average particle size between about 0.04 microns in diameter to about 500 microns in diameter, preferably between 0.2 microns and 30 microns. Advantageously, the liquid can comprise additional amine. The liquid may additionally or alternatively comprise dissolution agents, dispersion agents, suspension agents, antioxidants, acids, or combinations thereof. The copper metal should comprise between 10% and 80% by weight of the total slurry, typically between 20% and 50% by weight. A gallon of the slurry may contain up to about 5 pounds of copper metal and still be readily shakable and disbursable. In an alternate embodiment, the prepackaged composition may comprise greater than 80% by weight copper metal, wherein said copper metal is wetted form. The composition of the wetting solution can comprise many of the components found in granular or powder compositions, including small amounts of acids, disbursants, antioxidants, ammonia or alkanolamine, and the like. The wetting fluid may be aqueous or may comprise polar solvents, particularly alkanonamines such as monoethanolamine, diethanolamine, isopropanolamine, or mixtures thereof. Such a product can be likened to a pre-wetted powder product. The advantage over powdered products is elimination of dust and elimination or reduction of granulating and wetting agents.

Use of such prepackaged components easy even in difficult field conditions. The precursor material is a composition comprising a copper(II) complex, for example an aqueous copper(II) amine composition. The copper(II) monoethanolamine complex can be produced as disclosed in the U.S. patent application publication No. 20030162986, published Aug. 28, 2003 by Richardson and Zhao (2003) or by the dissolution of copper carbonate in monoethanolamine solutions. A typical aqueous copper(II) monoethanolamine carbonate concentrate composition will have about 0.9 pounds of copper(II) ions per gallon. Admixing and reacting a single gallon of a prepackaged copper metal slurry having 5 pounds of copper metal with 50 gallons of concentrate composition will provide about 50 gallons of a composition having both copper(I)-amine complexes and copper(II)-amine complexes, where the weight of copper is increased from 0.9 pounds per gallon to about 1 pound copper per gallon, and wherein the weight ratio of copper(I) to copper(I) is about 10:40 or 1:4. In addition to providing beneficial copper(I) amine complexed material to the wood preservative, it can be seen that shipping costs and volumes are minimized.

In another embodiment, copper metal is provided in an enclosure that is permeable to liquid but which confines the copper. Such an enclosure can be immersed in an aqueous copper(II) amine composition. Alternately or additionally, said enclosure can be part of a hose or pipe, where fluid is pumped through the enclosure. Pre-flushing the copper-containing enclosure with acid for a short period of time can help activate the copper surface. The aqueous copper(II) amine solution is then added to a tank loaded with copper metal and recycled by pumping the solution e.g., from the bottom of the tank and returned to the top of the tank until the copper concentration has increased by at least 25 percent and up to about 100%. This solution can then be diluted with water to a nominal use copper concentration of 0.5 or 1.0 percent, and the pH is adjusted to around 8.0 by carbonating, if necessary, or adding additional MEA.

Advantageously, the organic biocides are added after the copper(II) complex composition reacts with the copper metal to form a copper(I) complex. If particulate copper is used, advantageously at least an hour is allowed for reaction between the copper(II) and the copper metal prior to adding the organic biocides. The reason is that most organic biocides in use today are film-forming agents which have a tendency to coat copper particulates. In addition to such a coating lowering the reactivity of the copper metal, the copper metal particulates may strip the organic biocides from the composition. Some organic biocides will have a decreased tendency to coat metals, and these organic biocides are preferred if they are to be added prior to contacting a precursor copper(II) complex-containing composition with copper metal. Beneficially, the copper metal is reacted with an aqueous copper(II) amine concentrate (a composition comprising a higher concentration of copper than is required to be injected into wood), and then the reacted concentrate comprising copper(I) amine complexes is admixed with water, and the organic biocides are added when the concentrate is admixed with water.

Wood products for construction are typically treated in a mill, using a pressure process. The wood product is loaded into a vessel, then the vessel is filled with a water solution containing the preservative chemicals. The vessel is pressurized to force the solution into the wood. Most dimension lumber can be treated this way, as well as plywood and Parallam®. Other composite products, for example, OSB, LVL and glulam, can be preservative-treated during production. Preservative chemicals are added to the mix of wood flakes and/or to resin prior to pressing into boards. Preservatives can also be applied in the field, when a piece of treated lumber is cut. The chemicals in treated wood, even though they have been applied under pressure, often don't penetrate the wood all the way to the core.

The solutions of this invention are applied to the wood by vacuum and pressure using the standard apparatus found in the wood treating industry. Pre-flushing the wood with carbon dioxide followed by a vacuum will increase the wood preservative penetration into the wood. The process of injection of the solution should be nearly identical to what is practiced today. After the solution is injected into the wood the fixation process will begin to occur due to the low pH of the wood substrate. As the wood buffers the pH of the solution to lower values the in situ precipitation of the copper(I) oxide will begin. Wood products can also be treated in the normal manner. This will aid to fix the copper and render it relatively non-leachable compared to the cupric amine based wood preservative treatments. It may be advantageous to add acid to get to a pH of about 7.5 to about 8.5 prior to treatment.

The above descriptions are exemplary and describe preferred embodiments. Alternate embodiments will become apparent to one of skill in the art given the benefit of this disclosure, and therefore the embodiments described here are exemplary rather than limiting. Additional embodiments include for example adding one or more zinc salts to a preservative, adding one or more organic biocides to the preservative composition, forming copper(I) complexes out of other nitrogen-containing complexing molecules, and the like.

1. A method of preserving wood comprising:
providing an aqueous wood preservative composition comprising a copper(I)-alkanolamine complex; and
injecting the aqueous wood preservative composition into wood.

2. The method of claim 1 wherein the copper(I)-alkanolamine complex comprises a copper(I) monoethanolamine complex.

3. The method of claim 1 wherein the copper(I)-alkanolamine complex comprises monoethanolamine, diethanolamine, isopropanolamine, or combination thereof.

4. The method of claim 3 wherein the aqueous wood preservative composition further comprises ammonia.

5. The method of claim 1 wherein the aqueous wood preservative composition comprises an anion selected from a carbonate; acetate; formate; citrate; chloride; bromide; fluoride; iodide;
sulfate; borate; phosphate; sulfide; azide; chromite; cyanide; ferricyanide, or any combinations thereof.

6. The method of claim 1 wherein the aqueous wood preservative composition comprises an anion selected from a carbonate; borate; fluoride, or any combinations thereof.

7. The method of claim 1 wherein the aqueous wood preservative composition further comprises a copper(II)-alkanolamine complex.

8. The method of claim 7 wherein the aqueous wood preservative composition comprises between 2.1 to 3.5 moles of the alkanolamine per mole of copper ions.

9. The method of claim 7 wherein the mole ratio of copper(I) to copper(II) in the aqueous wood preservative composition is greater than 0.005:1.

10. The method of claim 7 wherein the mole ratio of copper(I) to copper(II) in the aqueous wood preservative composition is between about 0.01:1 to about 100:1.

11. The method of claim 7 wherein the mole ratio of copper(I) to copper(II) in the aqueous wood preservative composition is between about 0.05:1 to about 3:1.

12. The method of claim 1 wherein the aqueous wood preservative composition comprises a copper(I) monoethanolamine complex and further comprises a copper(II)-monoethanolamine complex.

13. The method of claim 12 wherein the aqueous wood preservative composition comprises between 2.1 to 3.5 moles of monoethanolamine per mole of copper ions.

14. The method of claim 12 wherein the aqueous wood preservative composition comprises between 2.2 to 3 moles of monoethanolamine per mole of copper ions.

15. The method of claim 12 wherein the mole ratio of copper(I) to copper(II) in the aqueous wood preservative composition is greater than 0.005:1.

16. The method of claim 12 wherein the mole ratio of copper(I) to copper(II) in the aqueous wood preservative composition is between about 0.01:1 to about 100:1.

17. The method of claim 12 wherein the mole ratio of copper(I) to copper(II) in the aqueous wood preservative composition is between about 0.05:1 to about 3:1.

18. The method of claim 1 wherein the step of providing the aqueous wood preservative composition comprising a copper(I)-alkanolamine complex comprises the steps of:
providing an aqueous precursor composition comprising a copper(II)-alkanolamine complex;
providing copper metal; and
reacting the aqueous precursor composition with the copper metal for a time sufficient to form copper(I)-alkanolamine complex, wherein the mole ratio of copper(I) to copper(I) in the aqueous wood preservative composition is greater than 0.005:1.

19. The method of claim 18 wherein the mole ratio of copper(I) to copper(II) in the aqueous wood preservative composition is between about 0.01:1 to about 100:1.

20. The method of claim 2 wherein the step of providing the aqueous wood preservative composition comprising a copper(I)-alkanolamine complex comprises the steps of:
providing an aqueous precursor composition comprising a copper(II)-monoethanolamine complex;
providing copper metal; and
reacting the aqueous precursor composition with the copper metal for a time sufficient to form copper(I)-monoethanolamine complex, wherein the mole ratio of copper(I) to copper(II) in the aqueous wood preservative composition is greater than 0.005:1.

21. The method of claim 20 wherein the mole ratio of copper(I) to copper(II) in the aqueous wood preservative composition is between about 0.01:1 to about 100:1.

22. The method of claim 20 wherein the aqueous precursor composition comprises copper(II)-monoethanolamine complex in an amount sufficient to provide between about 8% and about 14% by weight of soluble copper(I) based on the weight of the precursor composition.

23. The method of claim 1 wherein the wood preservative concentrate further comprises an effective amount of one or more antioxidants.

24. The method of claim 1 wherein the wood preservative concentrate further comprises between 0.3 ppm to 500 ppm of one or more antioxidants.

25. The method of claim 1 wherein the wood preservative concentrate further comprises one or more organic co-biocides.

26. The method of claim 1 wherein the wood preservative concentrate further comprises one or more organic and/or inorganic co-biocides different than the copper-alkanolamine complex.

27. A method of preserving wood comprising:
providing an aqueous wood preservative composition comprising a copper(I)-ammonia complex; and
injecting the aqueous wood preservative composition into wood.

28. The method of claim 27 wherein the aqueous wood preservative composition further comprises an alkanolamine.

29. The method of claim 27 wherein the aqueous wood preservative composition comprises an anion selected from a carbonate; acetate; formate; citrate; chloride; bromide; fluoride; iodide; sulfate; borate; phosphate; sulfide; azide; chromite; cyanide; ferricyanide, or any combinations thereof.

30. The method of claim 27 wherein the aqueous wood preservative composition comprises an anion selected from a carbonate; borate; fluoride, or any combinations thereof.

31. The method of claim 1 wherein the aqueous wood preservative composition further comprises a copper(II)-ammonia complex.

32. The method of claim 27 wherein the aqueous wood preservative composition comprises between 2.1 to 3.5 moles of ammonia per mole of copper ions.

33. The method of claim 27 wherein the mole ratio of copper(I) to copper(II) in the aqueous wood preservative composition is greater than 0.005:1.

34. The method of claim 27 wherein the mole ratio of copper(I) to copper(II) in the aqueous wood preservative composition is between about 0.01:1 to about 100:1.

35. The method of claim 27 wherein the mole ratio of copper(I) to copper(II) in the aqueous wood preservative composition is between about 0.05:1 to about 3:1.

36. The method of claim 33 wherein the aqueous wood preservative composition comprises between 2.2 to 3 moles of ammonia per mole of copper ions.

37. The method of claim 27 wherein the mole ratio of copper(I) to copper(II) in the aqueous wood preservative composition is between about 0.05:1 to about 3:1.

38. The method of claim 27 wherein the step of providing the aqueous wood preservative composition comprising a copper(I)-ammonia complex comprises the steps of:
providing an aqueous precursor composition comprising a copper(II)-ammonia complex;
providing copper metal; and
reacting the aqueous precursor composition with the copper metal for a time sufficient to form copper(I)-ammonia complex, wherein the mole ratio of copper(I) to copper(II) in the aqueous wood preservative composition is greater than 0.005:1.

39. The method of claim 38 wherein the mole ratio of copper(I) to copper(II) in the aqueous wood preservative composition is between about 0.01:1 to about 100:1.

40. The method of claim 38 wherein the aqueous precursor composition comprises copper(II)-ammonia complex in an amount sufficient to provide between about 8% and about 14% by weight of soluble copper(II) based on the weight of the precursor composition.

41. The method of claim 27 wherein the wood preservative concentrate further comprises an effective amount of one or more antioxidants.

42. The method of claim 27 wherein the wood preservative concentrate further comprises between 0.3 ppm to 500 ppm of one or more antioxidants.

43. The method of claim 27 wherein the wood preservative concentrate further comprises one or more organic co-biocides.

44. The method of claim 27 wherein the wood preservative concentrate further comprises one or more organic and/or inorganic co-biocides different than the copper-ammonia complex.

45. A method of preserving wood comprising:
providing an aqueous wood preservative composition comprising soluble complexed copper(I); and
injecting the aqueous wood preservative composition into wood.

46. The method of claim 45 wherein the soluble complexed copper(I) comprises a copper(I)-amine.

47. The method of claim 46 wherein the aqueous wood preservative composition comprises an anion selected from a carbonate; acetate; formate; citrate; chloride; bromide; fluoride; iodide; sulfate; borate; phosphate; sulfide; azide; chromite; cyanide; ferricyanide, or any combinations thereof.

48. The method of claim 46 wherein the aqueous wood preservative composition further comprises a copper(II)-amine complex.

49. The method of claim 46 wherein the amine comprises ammonia, monoethanolamine, isopropanolamine, diethanolamine, diglycolamine, monomethyl ethanolamine, 2-[(2-aminoethyl)-(2-hydroxyethyl)-amino]-ethanol, triethanolamine, N-aminoethyl-N′-hydroxyethyl-ethylenediamine, N,N′-dihydroxyethyl-ethylenediamine, 2-[2-(2-aminoethoxy)-ethylamino]-ethanol, 2-[2-(2-aminoethylamino)-ethoxy]-ethanol, 2-[2-(2-aminoethoxy)-ethoxy]-ethanol, tertiarybutyldiethanolamine, diisopropanolamine, n-propanolamine, isobutanolamine, 2-(2-aminoethoxy)-propanol, 1-hydroxy-2-aminobenzene, ethylenediamine, ethylenediamine diformic acid, ethylenediaminetetraformic acid, or mixtures thereof.

50. The method of claim 45 wherein the aqueous wood preservative composition further comprises soluble complexed copper(II), and wherein the mole ratio of copper(I) to copper(II) in the aqueous wood preservative composition is greater than 0.005:1.

51. The method of claim 50 wherein the aqueous wood preservative composition comprises between 2 to 3 moles of amines per mole of copper ions.

52. The method of claim 50 wherein the mole ratio of copper(I) to copper(I) in the aqueous wood preservative composition is between about 0.01:1 to about 100:1.

53. The method of claim 50 wherein the mole ratio of copper(I) to copper(II) in the aqueous wood preservative composition is between about 0.05:1 to about 3:1.

54. The method of claim 46 wherein the step of providing the aqueous wood preservative composition comprising a copper(I)-amine complex comprises the steps of:
providing an aqueous precursor composition comprising a copper(II)-amine complex;
providing copper metal; and
reacting the aqueous precursor composition with the copper metal for a time sufficient to form copper(I)-amine complex, wherein the mole ratio of copper(I) to copper(I) in the aqueous wood preservative composition is greater than 0.005:1.

55. The method of claim 45 wherein the wood preservative concentrate further comprises an effective amount of one or more antioxidants.

56. The method of claim 45 wherein the wood preservative concentrate further comprises one or more organic co-biocides.

57. The method of claim 46 wherein the wood preservative concentrate further comprises one or more organic and/or inorganic co-biocides different than the copper-amine(s) complex.

58. The method of claim 45 wherein the soluble complexed copper(I) comprises copper(I) and a soluble nitrile.

59. The method of any of claims 18, 20, 38, or 54, wherein the copper metal has about 1×10⁴ m² to 70 m² of surface area per gram of copper metal.

60. The method of any of claims 18, 20, 38, or 54, wherein the copper metal has about 10 m² to 60 m² of surface area per gram of copper metal.

61. The method of any of claims 18, 20, 38, or 54, wherein the step of providing copper metal comprises providing a powder or granulated material comprising very finely divided particulate copper having an average particle size between about 0.04 microns in diameter to about 500 microns in diameter.

62. The method of any of claims 18, 20, 38, or 54, wherein the copper metal is provided as a material having about 1×10⁻⁴ m² to 70 m² of surface area per gram of copper metal, said material additionally comprising a granulating agent, a dispersion agent, a dissolution agent, a suspension agent, a surfactant, an antifoaming agent, an antioxidant, an acid, or combinations thereof.

63. The method of any of claims 18, 20, 38, or 54, wherein the copper metal is added as a material having about 1×10 4 m² to 70 m² of surface area per gram of copper metal, said material additionally comprising ammonium sulfate, ammonium bisulfate, ammonium sulfite, ammonium phosphate, ammonium borate, ammonium chloride, ammonium fluoride, ammonium bromide, ammonium bicarbonate, ammonium carbonate, ammonium tartrate, ammonium bitartrate, or combinations thereof.

64. The method of any of claims 18, 20, 38, or 54, wherein the copper metal is activated prior to reacting with the aqueous copper(II) complex by etching with an acid.

65. The method of any of claims 18, 20, 38, or 54, wherein the copper metal is activated prior to reacting with the aqueous copper(II) complex by etching with dilute mineral acid and hydrogen peroxide.

66. The method of any of claims 18, 20, 38, or 54, wherein the copper metal is added as a slurry comprising between 10% to 80% of copper particles in liquid comprising an alkanolamine, ammonia, a dissolution agent, a dispersion agent, a suspension agent, an antioxidant, an acid, or combinations thereof.

67. The method of claim 66, wherein the surface area of the copper metal is from about 10 m²/g to about 60 m²/g.
